(19) United States
(12) Patent Application Publication
(10) Pub. No.: US 2025/0124547 A1
(43) Pub. Date: Apr. 17, 2025

(54) MONITORING SYSTEM AND METHOD HAVING PERIODIC ARTIFACT REDUCTION

(71) Applicant: Gentex Corporation, Zeeland, MI (US)

(72) Inventors: Mario F. Saenger Nayver, Holland, MI (US); Benjamin B. Hilldore, Holland, MI (US)

(21) Appl. No.: 18/916,991

(22) Filed: Oct. 16, 2024

Related U.S. Application Data
(60) Provisional application No. 63/590,645, filed on Oct. 16, 2023.

(51) Int. Cl. G06T 5/10; G06T 5/20; G06V 20/59

(52) U.S. Cl. CPC G06T 5/10; G06T 5/20; G06V 20/59; G06T 2207/20056

(57) ABSTRACT

The disclosure provides for a system for monitoring an operator of a vehicle, including: an electro-optic element: an illumination source configured to emit light through the electro-optic element toward the operator; an image sensor configured to image the operator; and a controller. The electro-optic element having two spaced apart substrates. The controller is configured to: receive a first image from the image sensor, the first image being represented in a spatial domain and having artifacts present; perform a transformation on the first image to create a transformed image in a domain other than the spatial domain; filter the transformed image to remove artifacts in the transformed image, wherein the filter is applied at an anticipated location of the artifacts based, at least in part, on a cell spacing between the two substrates; and perform an inverse transformation on the filtered transformed image to obtain an output image without artifacts.

### CROSS-REFERENCE TO RELATED APPLICATION

This application claims priority to and the benefit under 35 U.S.C. § 119 (e) of U.S. Provisional Patent Application No. 63/590,645, filed on Oct. 16, 2023, entitled “MONITORING SYSTEM AND METHOD HAVING PERIODIC ARTIFACT REDUCTION,” by Mario F. Saenger Nayver et al., the entire disclosure of which is incorporated herein by reference.

### TECHNOLOGICAL FIELD

The present invention generally relates to a monitoring system for a vehicle, and more particularly, to a monitoring system having an image sensor and illumination source disposed behind an electro-optic element of a rearview mirror assembly.

### SUMMARY OF THE DISCLOSURE

According to one aspect of the present disclosure, a monitoring system for monitoring an operator of a vehicle, comprising: an electro-optic element; an illumination source configured to emit light through the electro-optic element toward the operator of the vehicle; an image sensor configured to image a scene through the electro-optic element, wherein the scene includes the operator of the vehicle; and a controller. The electro-optic element comprising: a first substrate having a first surface and a second surface, the second surface having a first electrode; a second substrate having a third surface and a fourth surface, the second substrate disposed in a spaced apart relationship relative to the first substrate such that the second and third surfaces face one another, the third surface having a second electrode; and an electro-optic medium disposed between the first and second substrates. The controller is configured to: receive a first image from the image sensor, the first image being represented in a spatial domain and having artifacts present; perform a transformation on the first image to create a transformed image in a domain other than the spatial domain in which the first image was represented; apply a mask to the transformed image to remove artifacts as they appear in the transformed image, wherein the mask is applied at an anticipated location of the artifacts within the transformed image based, at least in part, on a cell spacing between the first and second substrates; and perform an inverse transformation on the masked transformed image to obtain an output image where the artifacts are not present.

According to another aspect of the present disclosure, a system for imaging an operator of a vehicle is provided, comprising: an electro-optic element comprising two substrates spaced apart from each other and having a cell spacing therebetween in which an electro-optic medium is disposed; an illumination source configured to emit light through the electro-optic element toward the operator of the vehicle; an image sensor configured to image a scene through the electro-optic element, wherein the scene includes the operator of the vehicle; and a controller configured to: receive a first image from the image sensor, the first image being represented in a spatial domain and having artifacts present; perform a transformation on the first image to create a transformed image in a domain other than the spatial domain in which the first image was represented; apply a filter to the transformed image to remove artifacts as they appear in the transformed image, wherein the filter is applied at an anticipated location of the artifacts within the transformed image based, at least in part, on a frequency of the light emitted from the illumination source; and perform an inverse transformation on the filtered transformed image to obtain an output image where the artifacts are not present.

According to another aspect of the present disclosure, a method is provided for imaging an operator of a vehicle using an image sensor configured to image a scene including the operator through an electro-optic element having a cell spacing between two substrates. The method comprising: receiving a first image from the image sensor, the first image being represented in a spatial domain and having artifacts present; performing a transformation on the first image to create a transformed image in a domain other than the spatial domain in which the first image was represented; applying a filter to the transformed image to remove artifacts as they appear in the transformed image, wherein the filter is applied at an anticipated location of the artifacts within the transformed image based, at least in part, on at least one of a cell spacing between the two substrates of the electro-optic element and a frequency of the light emitted from the illumination source; performing an inverse transformation on the filtered transformed image to obtain an output image where the artifacts are not present; and analyzing at least one characteristic of the operator in the output image.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a pair of images captured by an image sensor in which artifacts are present;

FIG. 2 is a projected view of an electro-optic assembly incorporated in an interior rearview mirror assembly to implement a monitoring system;

FIG. 3 is a perspective view of the interior of a vehicle in which the monitoring system is implemented;

FIG. 4 is a cross-section view of an electro-optic mirror assembly shown in FIGS. 2 and 3;

FIG. 5 is an electrical circuit diagram in block form of the monitoring system;

FIG. 6 shows two pairs of images with each pair including a raw image and a corresponding transformed image;

FIG. 7 is a series of images showing a progression of transformation, masking, and inverse transformation using the monitoring system shown in FIG. 5; and

FIG. 8 is a flowchart of a method performed by the monitoring system shown in FIG. 5.

### DETAILED DESCRIPTION

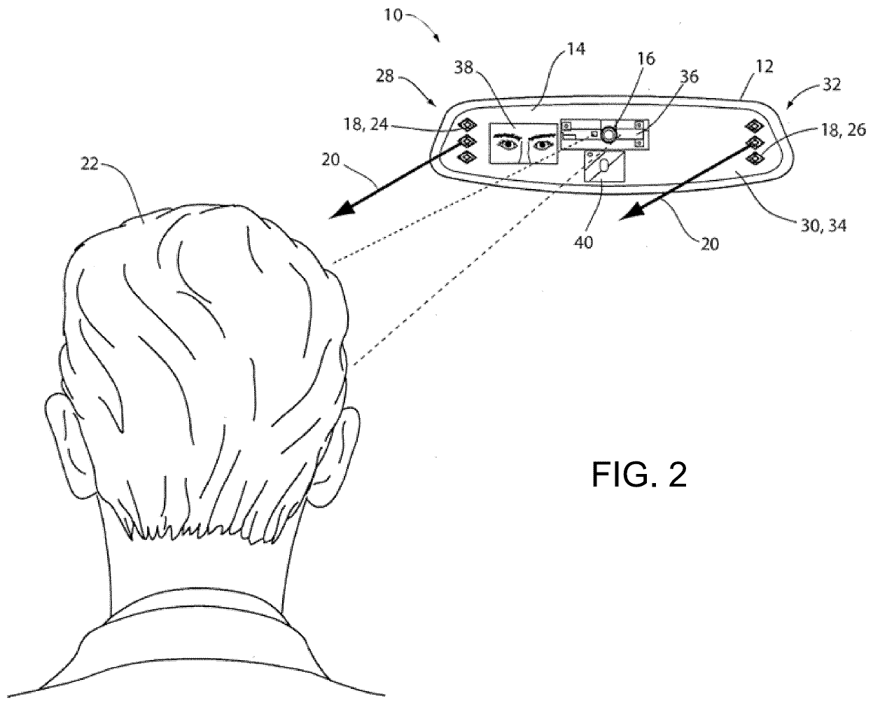

For purposes of description herein, the terms “upper,” “lower,” “right,” “left,” “rear,” “front,” “vertical,” “horizontal,” and derivatives thereof shall relate to the invention as oriented in FIG. 2. Unless stated otherwise, the term “front” shall refer to the surface of the mirror element closer to an intended viewer of the mirror element, and the term “rear” shall refer to the surface of the element further from the intended viewer of the mirror element. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

It has been proposed to provide a rearview mirror assembly for a vehicle in which an image sensor is positioned behind an electro-optic mirror element along with infrared (IR) light emitting diodes (LEDs) that illuminate the scene to be imaged. The images captured by the image sensor may be used to monitor an operator of the vehicle and/or to identify the driver. An example of such a monitoring system is disclosed in commonly-assigned U.S. Pat. No. 10,766,422. Such a system is advantageous in that it locates the image sensor and LEDs in an ideal location to view the driver while hiding the image sensor and LEDs from view.

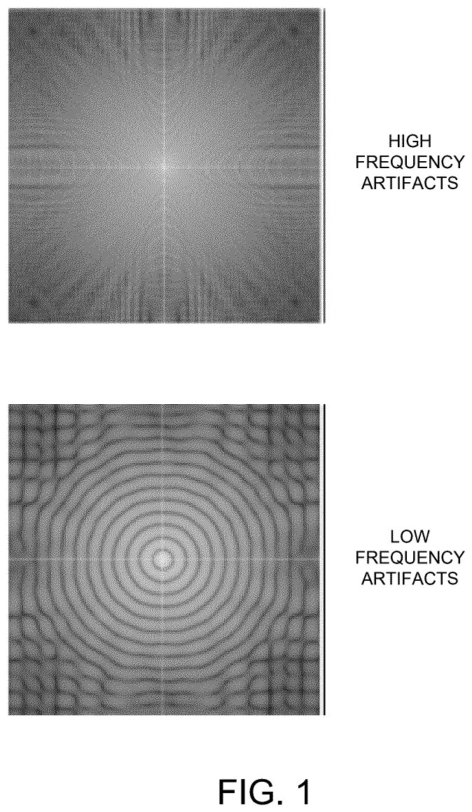

However, a problem with placing a monochromatic light source such as the IR LEDS behind the electro-optic mirror element is the appearance of repetitive periodic patterns stemming from an interference pattern due to the interaction of the monochromatic light with the electro-optic element. In particular, the cell spacing of the electro-optic element causes reflections at the inner surfaces of its substrates, which results in ring pattern artifacts in the images. The location of these periodic artifacts is determined largely based on the size of the cell spacing and partially on the frequency and coherence length of the light emitted from the IR LEDs. For a typical electrochromic element, the cell spacing is 125 μm and the coherence length of IR light is about 414 μm. Interference occurs due to multiple reflections at interfaces within the electro-optic element when the cell spacing is smaller than the coherence length of the light. FIG. 1 shows two examples of these artifacts for different frequencies. The embodiment disclosed below solves this problem.

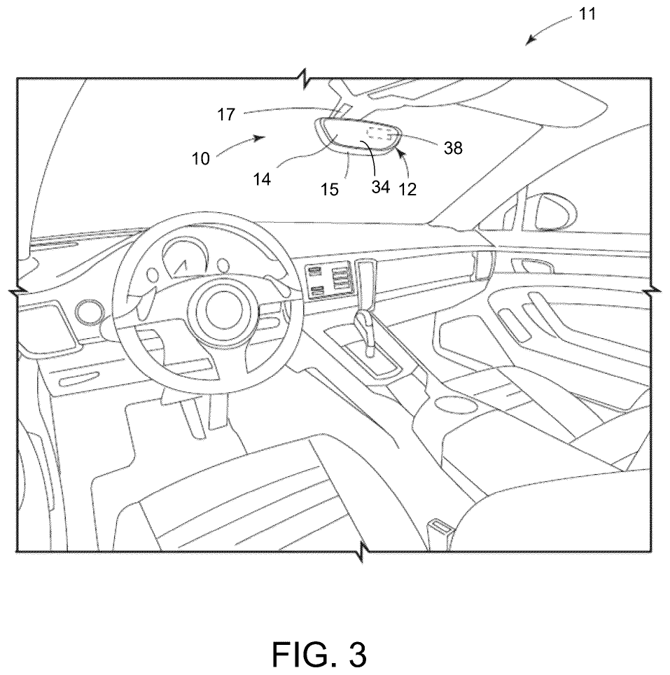

FIGS. 2 and 3 show a monitoring system 10 for a vehicle 11 operable to perform driver monitoring and/or identification functions. In an exemplary embodiment, the monitoring system 10 may be incorporated in whole or in part within a rearview mirror assembly 12 comprising an electro-optic assembly 14 for an automotive vehicle. The rearview mirror assembly 12 may include a housing 15 defining an opening in which the electro-optic element 14 is positioned. The electro-optic assembly 14 may contain various forms of transflective mirror devices and in some embodiments may comprise an electrochromic (EC) mirror element 34. In this configuration, the electrochromic mirror element 34 can vary in reflectivity in response to a control signal from a controller. The control signal may change an electrical potential supplied to the electro-optic assembly 14 to control the reflectivity.

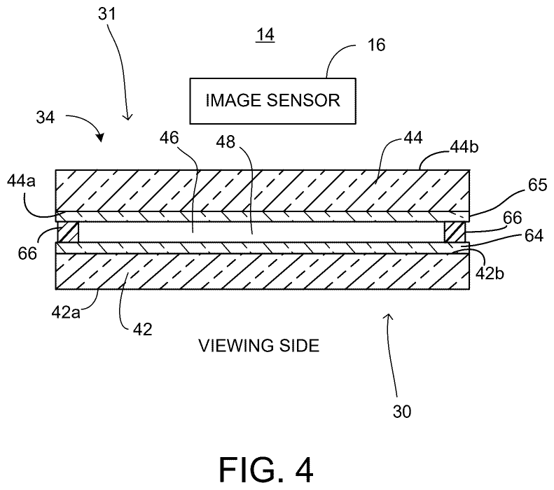

The monitoring system 10 may further include an image sensor 16 provided behind and proximate a rear surface 31 (FIG. 4) of the electro-optic assembly 14 so as to capture images of an operator 22 of the vehicle. In addition, the monitoring system 10 may include at least one light source 18, which may correspond to one or more infrared emitters configured to output an emission 20 of light in the near IR (NIR) range. In this configuration, one or more infrared emitters corresponding to the at least one light source 18 may be selectively activated to illuminate the operator 22 of the vehicle.

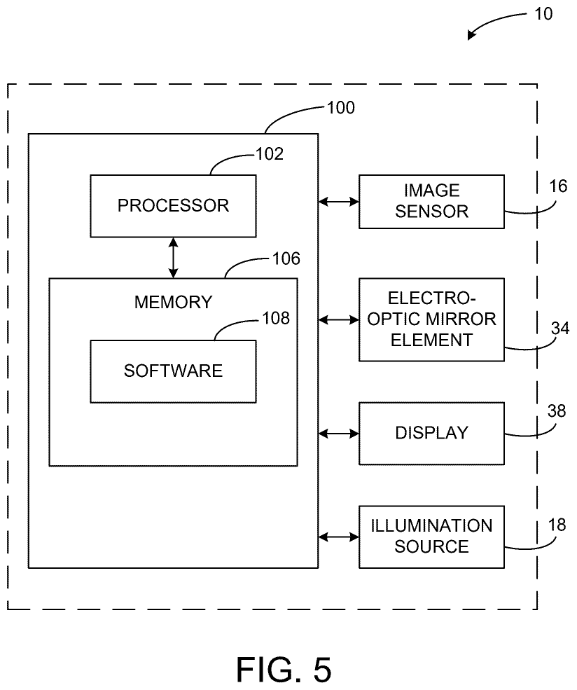

The image sensor 16 may be disposed on a printed circuit board in communication with a controller 100 (FIG. 5). The controller 100 may further be in communication with various devices that may be incorporated in the vehicle 11 via the communication bus or any other suitable communication interface. The controller 100 may correspond to one or more processors 102 or circuits, which may be configured to process image data received from the image sensor 16. In this configuration, the image data may be communicated from the image sensor 16 to the controller 100. The controller 100 may further selectively activate one or more infrared emitters corresponding to the at least one light source 18.

Referring to FIG. 4, a cross-sectional view of the electro-optic mirror assembly 14 is shown. The electro-optic assembly 14 may be partially reflective and partially transmissive and comprise the mirror element 34. The mirror element 34 may include a first substrate 42 having a first surface 42a and a second surface 42b. The mirror element 34 may further comprise a second substrate 44 having a third surface 44a and a fourth surface 44b. The first substrate 42 and the second substrate 44 may define a cavity 46 and may be substantially parallel. The first surface 42a and the third surface 44a may be oriented toward the front surface 30 of the mirror assembly 12. The second surface 42b and the fourth surface 44b may be oriented toward a rear surface 31 of the mirror assembly 12. A transparent first electrode 64 is disposed on the second surface 42b and a reflective second electrode 65 may be placed on the third surface 44a.

The cavity 46 may contain an electro-optic medium 48, such as, but not limited to, an electrochromic medium. The cavity 46 may be completely or partially filled with the medium 48. The mirror assembly 12 may be in communication with a controller 100 (FIG. 5) via electrical contacts coupled to first electrode 64 and second electrode 65. The mirror element 34 may comprise various seals 66 to retain the medium 48 in the cavity 46. In this configuration, the mirror element 34 may be configured to vary in reflectance in response to a control signal received from the controller 100 via the electrical contacts and electrodes 64 and 65.

Each of the surfaces 42a, 42b, 44a, and 44b corresponds to interfaces of the mirror assembly 12. The reflective second electrode 65 may include a transflective coating. The transflective coating may typically comprise a layer containing silver along with additional layers such as metal, dielectric and/or transparent conducting oxides located above or below the silver layer or both.

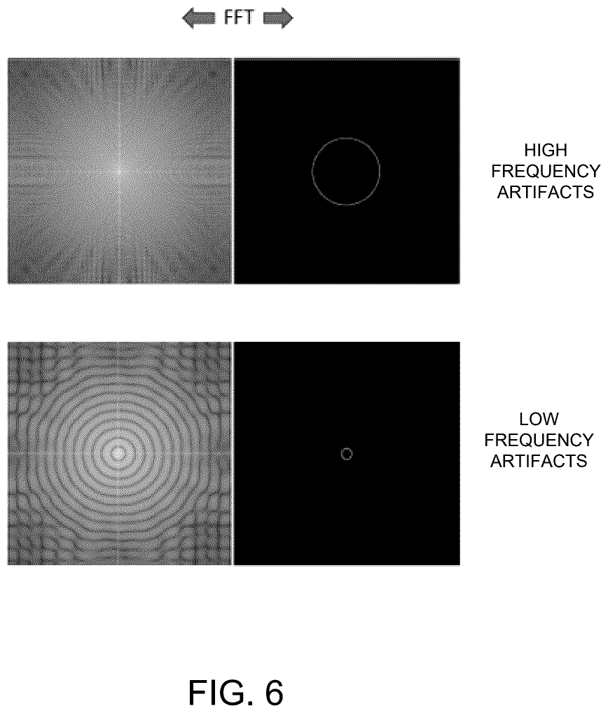

Because the cell spacing (the distance between the second and third surfaces 42b and 44a) is known and the frequency of the monochromatic illuminating IR light from the LEDs 18 is known, the location and nature of the periodic ring pattern artifacts in the images caused by the electro-optic element 34 can be predicted and thus removed from the images. FIG. 6 shows the artifacts shown in FIG. 1 at two different frequencies of illumination along with corresponding images in the frequency domain resulting from a Fast Fourier Transform (FFT). As shown in the frequency domain, the artifacts appear as a single circle with the diameter of the circle increasing with higher frequencies.

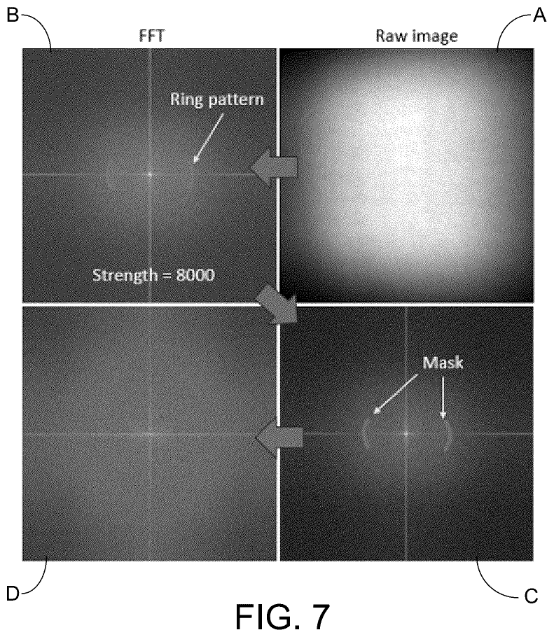

One example of how to remove the artifacts is to apply a Fourier Transform (more specifically, an FFT) to the captured image to isolate the single frequency artifacts, remove the artifacts in the frequency domain, and then convert the image with a second transform back to reproduce an image without the periodic artifact. As shown in FIG. 7, the raw image A is subjected to an FFT to produce a transformed image B in the frequency domain. As shown, a ring pattern appearing as a pair of parentheses is present in the transformed image. The distance between these parentheses increases with increased cell spacing. Next, a mask C is applied to the transformed image that removes the artifacts in the frequency domain. Then, the masked transformed image is subjected to an inverse transform that results in the image D that has the artifacts removed.

Although the use of a Fourier Transform is discussed above, other transforms may be used such as a Hough transform that transforms the raw image into a domain different from the spatial domain in which it is originally presented. Moreover, although the use of a mask is discussed above, any form of filter may be used to remove the artifacts.

The controller 100 (specifically the processor 102) may process the image data with one or more software algorithms 108 stored in memory 106 (FIG. 5). More specifically, the controller 100 may be configured to: receive a first image from the image sensor 16, the first image being represented in a spatial domain and having artifacts present; perform a transformation on the first image to create a transformed image in a domain other than the spatial domain in which the first image was represented; apply a mask to the transformed image to remove artifacts as they appear in the transformed image, wherein the mask is applied at an anticipated location of the artifacts within the transformed image based, at least in part, on a cell spacing between the first and second substrates 42 and 44; and perform an inverse transformation on the masked transformed image and to obtain an output image where the artifacts are not present.

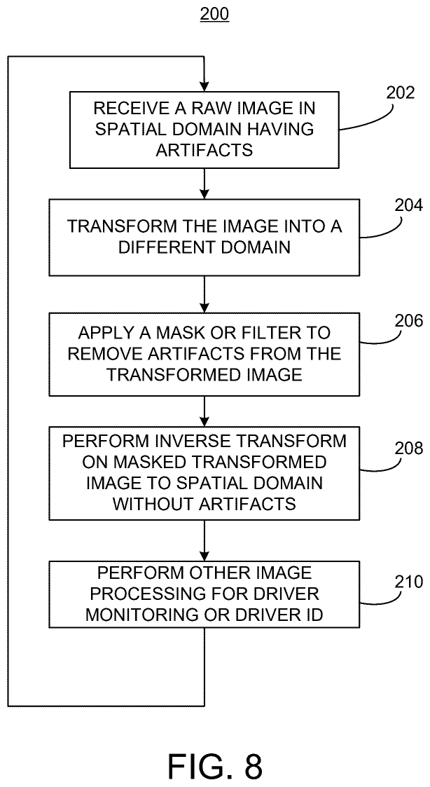

FIG. 8 is a flowchart illustrating a method 200 that may be executed by processor 102 in order to remove artifacts from the raw images received from the image sensor 16. The method 200 begins with step 202 in which a raw image is received in the spatial domain with the raw image including artifacts. The raw image is then transformed into a different domain than the spatial domain in step 204. This may be a frequency domain, for example. Then, a mask or filter is applied to remove the artifacts from the transformed image in step 206. Next, in step 208, an inverse transform is performed on the masked transformed image to transform the image back into the spatial domain but without the artifacts. The output image may then be subjected to other image processing (step 210) for performing either a driver monitoring function or a driver identification function. Step 210 may be performed by processor 102 or may be performed by a different processor. The method 200 may be repeated for each raw image received.

As noted above, the monitoring system 10 may be configured to process and/or control an identification function or a driver monitoring function. The identification function may comprise an eye-scan or retinal identification function. In this configuration, the monitoring system 10 may provide for the interior rearview mirror assembly 12 to be configured to identify an operator or passenger of a vehicle based on the eye-scan identification function. The identification function may be processed by the controller and/or communicated from the controller to one or more vehicle systems to provide for an identification of the operator or passenger of the vehicle.

The eye-scan-identification function may both utilize an infrared illumination of an iris of an eye for the identification or of the driver's upper body for monitoring. The illumination may be optimized in conditions allowing for a high optical transmittance in the near infrared (NIR) range. Additionally, the driver monitoring function may utilize the infrared illumination of the operator 22 for imaging the operator during dark conditions.

The infrared emitters or the light sources 18 may correspond to a plurality of infrared emitter banks. Each of the infrared emitter banks may comprise a plurality of light emitting diodes, which may be grouped in a matrix or otherwise grouped and disposed behind a rear surface of the electro-optic device. In an exemplary embodiment, the plurality of light sources 18 may correspond to a first emitter bank 24 and a second emitter bank 26. The first emitter bank 24 may be configured to output the emission in the NIR range from a first side portion 28 of a front surface 30 of the electro-optic assembly 14. The second emitter bank 26 may be configured to output the emission in the NIR range from a second side portion 32 of the front surface 30 of the electro-optic assembly 14, which may comprise a mirror element 34 of the mirror assembly 12. In this configuration, the monitoring system 10 may be configured to illuminate the operator 22 such that the image sensor 16 may capture an image of the operator.

In an exemplary embodiment, each of the first emitter bank 24 and/or the second emitter bank 26 may correspond to more or fewer LEDs or banks of LEDs. In some embodiments comprising an electro-optic assembly having a high level of transmittance in the NIR range, the scanning apparatus 10 may utilize fewer or less intense LEDs.

The image sensor 16 may correspond to, for example, a digital charge-coupled device (CCD) or complementary metal-oxide-semiconductor (CMOS) active pixel sensor, although not be limited to these exemplary devices.

The controller 100 may further be in communication with an optional display 38. The display 38 may be disposed in the mirror assembly 12 behind the rear surface. The controller 100 may be operable to display the image data received from the image sensor 16 such that the operator may view the image data. In this configuration, the operator 22 may adjust a position of the eyes shown on the display 38 to position the eyes such that the image data may include the necessary features required to identify the operator. In an exemplary embodiment, the features required to identify the operator of the vehicle may correspond to features of the eyes of the operator 22 (e.g. the irises).

The display 38 may correspond to a partial or full display mirror configured to display an image through at least a portion of the mirror assembly 12. The display 38 may be constructed utilizing various technologies, for example LCD, LED, OLED, plasma, DLP or other display technology. Examples of display assemblies that may be utilized with the disclosure may include U.S. Pat. No. 6,572,233 “REARVIEW MIRROR WITH DISPLAY,” U.S. Pat. No. 8,237,909 entitled “VEHICULAR REARVIEW MIRROR ASSEMBLY INCLUDING INTEGRATED BACKLIGHTING FOR A LIQUID CRYSTAL DISPLAY (LCD),” U.S. Pat. No. 8,411,245 “MULTI-DISPLAY MIRROR SYSTEM AND METHOD FOR EXPANDED VIEW AROUND A VEHICLE,” and U.S. Pat. No. 8,339,526 “VEHICLE REARVIEW MIRROR ASSEMBLY INCLUDING A HIGH INTENSITY DISPLAY,” which are incorporated herein by reference in their entirety.

The monitoring system 10 may further comprise an indicator 40 in the mirror assembly 12. The indicator 40 may be in communication with the controller and configured to output a signal to identify a state of the monitoring system 10 and/or a rearview image sensor. The indicator may correspond to a light source that may be operable to flash and/or change colors to communicate a state of the scanning apparatus 10. The indicator 40 may correspond to a light emitting diode (LED), and in an exemplary embodiment, the indicator 40 may correspond to a red, green, and blue (RGB) LED operable to identify the state of the scanning apparatus 10 by outputting one of more colored emissions of light.

In some embodiments, the mirror element 34 may be an electro-chromic element or an element such as a prism. One non-limiting example of an electro-chromic element is an electrochromic medium, which includes at least one solvent, at least one anodic material, and at least one cathodic material. Typically, both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference. Electrochromic components, as described herein, include materials whose color or opacity are affected by electric current, such that when an electrical current is applied to the material, the color or opacity change from a first phase to a second phase. The electrochromic component may be a single-layer, single-phase component, multi-layer component, or multi-phase component, as described in U.S. Pat. No. 5,928,572 entitled “ELECTROCHROMIC LAYER AND DEVICES COMPRISING SAME,” U.S. Pat. No. 5,998,617 entitled “ELECTROCHROMIC COMPOUNDS,” U.S. Pat. No. 6,020,987 entitled “ELECTROCHROMIC MEDIUM CAPABLE OF PRODUCING A PRE-SELECTED COLOR,” U.S. Pat. No. 6,037,471 entitled “ELECTROCHROMIC COMPOUNDS,” U.S. Pat. No. 6,141,137 entitled “ELECTROCHROMIC MEDIA FOR PRODUCING A PRESELECTED COLOR,” U.S. Pat. No. 6,241,916 entitled “ELECTROCHROMIC SYSTEM,” U.S. Pat. No. 6,193,912 entitled “NEAR INFRARED-ABSORBING ELECTROCHROMIC COMPOUNDS AND DEVICES COMPRISING SAME,” U.S. Pat. No. 6,249,369 entitled “COUPLED ELECTROCHROMIC COMPOUNDS WITH PHOTOSTABLE DICATION OXIDATION STATES,” and U.S. Pat. No. 6,137,620 entitled “ELECTROCHROMIC MEDIA WITH CONCENTRATION-ENHANCED STABILITY, PROCESS FOR THE PREPARATION THEREOF AND USE IN ELECTROCHROMIC DEVICES”; U.S. Pat. No. 6,519,072, entitled “ELECTROCHROMIC DEVICE”; and International Patent Application Serial Nos. PCT/US98/05570 entitled “ELECTROCHROMIC POLYMERIC SOLID FILMS, MANUFACTURING ELECTROCHROMIC DEVICES USING SUCH SOLID FILMS, AND PROCESSES FOR MAKING SUCH SOLID FILMS AND DEVICES,” and PCT/EP98/03862 entitled “ELECTROCHROME POLYMER SYSTEMS,” which are herein incorporated by reference in their entirety.

The present disclosure may be used with a mounting system 17 (FIG. 3) such as that described in U.S. Pat. Nos. 9,174,577; 8,925,891; 9,838,653; 8,960,629; 9,244,249; 8,814,373; 8,201,800; and 8,210,695, which are hereby incorporated herein by reference in their entirety. Further, the present disclosure may be used with a rearview packaging assembly such as that described in U.S. Pat. Nos. 8,814,373; 8,646,924; 8,643,931; 8,885,240; 9,056,584; and 8,264,761, which are hereby incorporated herein by reference in their entirety. Additionally, it is contemplated that the present disclosure can include a bezel such as that described in U.S. Pat. Nos. 8,827,517; 8,210,695; and 8,201,800, which are hereby incorporated herein by reference in their entirety.

It will be appreciated that embodiments of the invention described herein may be comprised of one or more conventional processors and unique stored program instructions that control one or more processors to implement, in conjunction with certain non-processor circuits, some, most, or all the functions of a mirror assembly 12, as described herein. The non-processor circuits may include, but are not limited to signal drivers, clock circuits, power source circuits, and/or user input devices. As such, these functions may be interpreted as steps of a method used in using or constructing a classification system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, the methods and means for these functions have been described herein. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A monitoring system for monitoring an operator of a vehicle, comprising:
an electro-optic element comprising:
a first substrate having a first surface and a second surface, the second surface having a first electrode;
a second substrate having a third surface and a fourth surface, the second substrate disposed in a spaced apart relationship relative to the first substrate such that the second and third surfaces face one another, the third surface having a second electrode; and
an electro-optic medium disposed between the first and second substrates;
an illumination source configured to emit light through the electro-optic element toward the operator of the vehicle;
an image sensor configured to image a scene through the electro-optic element, wherein the scene includes the operator of the vehicle; and
a controller configured to:
receive a first image from the image sensor, the first image being represented in a spatial domain and having artifacts present;
perform a transformation on the first image to create a transformed image in a domain other than the spatial domain in which the first image was represented;
apply a mask to the transformed image to remove artifacts as they appear in the transformed image, wherein the mask is applied at an anticipated location of the artifacts within the transformed image based, at least in part, on a cell spacing between the first and second substrates; and
perform an inverse transformation on the masked transformed image to obtain an output image where the artifacts are not present.

2. The monitoring system of claim 1, wherein the anticipated location of the artifacts in the transformed image is also based on a frequency of the light emitted from the illumination source.

3. The monitoring system of claim 1, wherein the controller performs the transformation of the first image to create the transformed image in the frequency domain.

4. The monitoring system of claim 1, wherein the controller performs the transformation of the first image by performing a Fourier Transform on the first image.

5. The monitoring system of claim 4, wherein the Fourier Transform is a Fast Fourier Transform.

6. The monitoring system of claim 1, wherein the controller performs the inverse transformation of the masked transformed image by performing an inverse Fourier Transform on the masked transformed image.

7. The monitoring system of claim 1, wherein the electro-optic medium is an electrochromic medium.

8. A system for imaging an operator of a vehicle, comprising:
an electro-optic element comprising two substrates spaced apart from each other and having a cell spacing therebetween in which an electro-optic medium is disposed;
an illumination source configured to emit light through the electro-optic element toward the operator of the vehicle;
an image sensor configured to image a scene through the electro-optic element, wherein the scene includes the operator of the vehicle; and
a controller configured to:
receive a first image from the image sensor, the first image being represented in a spatial domain and having artifacts present;
perform a transformation on the first image to create a transformed image in a domain other than the spatial domain in which the first image was represented;
apply a filter to the transformed image to remove artifacts as they appear in the transformed image, wherein the filter is applied at an anticipated location of the artifacts within the transformed image based, at least in part, on a frequency of the light emitted from the illumination source; and
perform an inverse transformation on the filtered transformed image to obtain an output image where the artifacts are not present.

9. The system of claim 8, wherein the anticipated location of the artifacts in the transformed image is also based on a cell spacing between the two substrates of the electro-optic element.

10. The system of claim 8, wherein the controller performs the transformation of the first image to create the transformed image in the frequency domain.

11. The system of claim 8, wherein the controller performs the transformation of the first image by performing a Fourier Transform on the first image.

12. The system of claim 11, wherein the Fourier Transform is a Fast Fourier Transform.

13. The system of claim 8, wherein the controller performs the inverse transformation of the filtered transformed image by performing an inverse Fourier Transform on the filtered transformed image.

14. The system of claim 8, wherein the filter is a mask.

15. A method of imaging an operator of a vehicle using an image sensor configured to image a scene including the operator through an electro-optic element having a cell spacing between two substrates, the method comprising:
receiving a first image from the image sensor, the first image being represented in a spatial domain and having artifacts present;
performing a transformation on the first image to create a transformed image in a domain other than the spatial domain in which the first image was represented;
applying a filter to the transformed image to remove artifacts as they appear in the transformed image, wherein the filter is applied at an anticipated location of the artifacts within the transformed image based, at least in part, on at least one of a cell spacing between the two substrates of the electro-optic element and a frequency of the light emitted from the illumination source;
performing an inverse transformation on the filtered transformed image to obtain an output image where the artifacts are not present; and
analyzing at least one characteristic of the operator in the output image.

16. The method of claim 15, wherein the filter is a mask.

17. The method of claim 15, wherein the transformation of the first image creates the transformed image in the frequency domain.

18. The method of claim 15, wherein the step of performing the transformation of the first image includes performing a Fourier Transform on the first image.

19. The method of claim 18, wherein the Fourier Transform is a Fast Fourier Transform.

20. The method of claim 15, wherein the step of performing the inverse transformation of the filtered transformed image includes performing an inverse Fourier Transform on the filtered transformed image.
